(19) United States
(12) Patent Application Publication
(10) Pub. No.: US 2026/0022531 A1
(43) Pub. Date: Jan. 22, 2026

(54) VAPOR BARRIER AND INSULATION SYSTEM WITH FIBROUS ATTACHMENT LAYER

(71) Applicant: Your Crawl Space, Inc., Awendaw, SC (US)

(72) Inventor: Henry Bennie Marshall, III, McClellanville, SC (US)

(21) Appl. No.: 19/274,908

(22) Filed: Jul. 21, 2025

Related U.S. Application Data
(60) Provisional application No. 63/673,272, filed on Jul. 19, 2024.

(51) Int. Cl. E02D 31/02; B32B 3/18; B32B 3/26; B32B 3/30; B32B 5/02; B32B 5/18; B32B 5/26; B32B 7/12; B32B 27/06; B32B 27/12; B32B 27/32

(52) U.S. Cl. CPC E02D 31/02; B32B 3/18; B32B 3/266; B32B 3/30; B32B 5/022; B32B 5/18; B32B 5/265; B32B 7/12; B32B 27/065; B32B 27/12; B32B 27/32; B32B 2250/05; B32B 2262/0253; B32B 2307/304; B32B 2307/416; B32B 2307/554; B32B 2307/7246; B32B 2307/73; B32B 2607/00

(57) ABSTRACT

A vapor barrier and insulation system for a foundation wall includes a non-woven fibrous outer layer configured to engage and grab onto a vertical foundation surface, a moisture impervious vapor barrier layer carried on the non-woven fibrous outer layer opposite a side arranged for engaging the foundation surface, an insulation material carried by the vapor barrier layer on a side opposite the non-woven fibrous outer layer such that the vapor barrier layer is disposed between the insulation material and the non-woven fibrous outer layer, a ventilated cover layer disposed adjacent to the insulation material and constructed to enclose the insulation material together with the vapor barrier layer, and a tail section comprised of a portion of the non-woven fibrous outer layer and the moisture impervious vapor barrier layer extending below the insulation material and the ventilated cover layer.

### FIELD OF INVENTION

The present disclosure relates to vapor barrier systems for buildings, and more particularly to a vapor barrier and insulation system with a fibrous attachment layer for foundation walls. The system helps protect and insulate foundation walls by providing both moisture control and thermal insulation to foundation walls.

### BACKGROUND

Crawlspaces are common features in many residential and commercial buildings, providing access to plumbing, electrical, and other systems beneath the structure. These spaces are typically enclosed by foundation walls and are often exposed to moisture from the surrounding soil and environment. Uncontrolled moisture in crawlspaces can lead to various issues, including mold growth, wood rot, insect infestations, and structural damage over time. This can result in an unhealthy environment for inhabitants within the living spaces of the structure above.

Traditional crawlspaces are often poorly insulated and may have inadequate protection from external environmental factors. Due to various openings such as vents, cracks, and leaks in the foundation walls or floor, these spaces may be exposed to outdoor air, moisture, and temperature fluctuations. Further, due to limited airflow in a crawlspace, moisture that seeps out of the ground and into the crawlspace causes the crawlspace to become damp and may stay damp for extended periods of time. This moisture can be very damaging to the structure's foundation walls, foundation piers, floor joists, and other structural components, often leading to premature deterioration of the structure and costly repairs. This exposure can lead to energy inefficiency in the building above, as well as create conditions conducive to mold growth, pest infestations, and structural deterioration. In some cases, the lack of proper insulation and sealing may result in drafts, uneven temperatures in living spaces, and increased energy costs for heating and cooling. Additionally, the exposure to outdoor elements may introduce pollutants, allergens, and humidity into the crawlspace, potentially affecting indoor air quality throughout the building.

Common approaches to managing moisture in crawlspaces have included ventilation and the use of vapor barriers on the ground. However, these methods may not adequately address moisture issues in all situations, particularly in humid climates or areas with high water tables. Additionally, many crawlspaces lack proper insulation, which can result in energy inefficiency and comfort issues in the living spaces above.

There is growing recognition of the benefits of creating conditioned crawlspaces, where the space is sealed, insulated, and integrated into the building's heating and cooling system. This approach aims to control moisture, improve energy efficiency, and enhance indoor air quality. However, implementing effective moisture control and insulation systems in crawlspaces presents several challenges.

One challenge is securely attaching vapor barriers and insulation materials to foundation walls, which are often made of concrete or masonry. These surfaces can be uneven, damp, and difficult to adhere to using conventional methods. Mechanical fasteners like nails or screws may compromise the integrity of the foundation or the vapor barrier itself. Adhesives used in crawlspace environments need to be low in volatile organic compounds (VOCs) due to limited ventilation and potential health concerns.

Another consideration is the integration of vapor barriers with insulation materials to create a comprehensive system that addresses both moisture control and thermal performance. Such systems need to be durable, resistant to pests and mold, and capable of maintaining their effectiveness over the long term in the challenging crawlspace environment.

Furthermore, installation of vapor barrier and insulation systems in existing crawlspaces can be complicated by limited access, confined spaces, and the presence of obstacles such as pipes, ductwork, and support structures. Systems that are easier to install and can be adapted to various crawlspace configurations are desirable.

As building practices evolve and energy efficiency standards become more stringent, there is an ongoing need for improved methods and materials for managing moisture and thermal performance in crawlspaces. Advancements in this area have the potential to enhance building durability, energy efficiency, and indoor environmental quality.

Accordingly, it is an object of the present invention to provide a vapor barrier and insulation system designed to install quickly and efficiently on foundation walls without requiring mechanical fasteners that penetrate the wall surface.

Additionally, it is an object of the present invention to provide a vapor barrier and insulation system that allow for effective water and moisture management. In some cases, the system may be configured to direct water and moisture away from foundation walls and towards drainage systems. This approach helps prevent water accumulation against foundation surfaces and facilitates the removal of excess moisture from the crawlspace environment.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a vapor barrier and insulation system for a foundation wall is provided. The system may include a non-woven fibrous outer layer configured to engage and grab onto a vertical foundation surface. A moisture impervious vapor barrier layer may be carried on the non-woven fibrous outer layer opposite the side arranged for engaging the foundation surface. An insulation material may be carried by the vapor barrier layer on the side opposite the non-woven fibrous outer layer such that the vapor barrier layer is disposed between the insulation material and the non-woven fibrous outer layer. A ventilated cover layer may be disposed adjacent to the insulation material and constructed to enclose the insulation material together with the vapor barrier layer. In some aspects, the system may include a tail section comprised of a portion of the non-woven fibrous outer layer and the moisture impervious vapor barrier layer extending below the insulation material and the ventilated cover layer.

In some implementations, the non-woven fibrous outer layer may comprise hydrophobic polypropylene fibers. These fibers may be configured to draw moisture away from the foundation surface. The moisture impervious vapor barrier layer may comprise a multi-layered polyethylene film in certain aspects. In some cases, at least one layer of the multi-layered polyethylene film may include ground nylon for puncture and abrasion resistance.

The ventilated cover layer may include a series of perforations to allow airflow between the insulation material and exterior of the ventilated cover layer. In some implementations, the ventilated cover layer may comprise a top edge portion and a bottom edge portion, each including an adhesive layer for sealing the ventilated cover layer to the vapor barrier layer.

According to another aspect of the present disclosure, a vapor barrier system for a foundation wall is provided. The system may include a non-woven fibrous outer layer of hydrophobic fibers for engaging a vertical foundation surface and drawing moisture away from the foundation surface. A multi-layered moisture impervious vapor barrier sheet may be carried on the non-woven fibrous outer layer opposite a side arranged for engaging the foundation surface. In some aspects, the vapor barrier sheet may include a polyethylene film applied to the fibrous outer layer, and at least one layer of the vapor barrier sheet may include ground nylon for puncture and abrasion resistance.

In some implementations, the hydrophobic fibers may comprise polypropylene fibers. These fibers may be configured to form air pockets between the fibers to increase capillary effect for drawing water away from the foundation surface. The multi-layered moisture impervious vapor barrier sheet may comprise at least seven layers in certain aspects. At least one layer of the multi-layered moisture impervious vapor barrier sheet may include additives selected from the group consisting of soil gas prohibitors, UV protection additives, antimicrobial additives, and fire retardant additives. In a further arrangement, a rigid form board may be mounted to the vapor barrier sheet.

The system may further include a tail section extending from a bottom portion of the vapor barrier system. This tail section may be configured to transition from a vertical orientation along the foundation wall to a horizontal orientation along a floor surface. In some implementations, the tail section may be configured to engage with a floor covering to provide a continuous moisture barrier from the foundation wall to the floor surface.

In another aspect, a vapor barrier and insulation assembly for a foundation wall is provided. The assembly may include a non-woven synthetic fiber layer configured to engage a foundation surface without mechanical fasteners, a moisture impervious layer attached to the non-woven synthetic fiber layer, an insulation layer adjacent to the moisture impervious layer, and a perforated cover layer enclosing the insulation layer.

The non-woven synthetic fiber layer may comprise hydrophobic polypropylene fibers configured to draw moisture away from the foundation surface in some implementations. These hydrophobic polypropylene fibers may form air pockets between the fibers to increase capillary effect for drawing water away from the foundation surface.

In certain aspects, the moisture impervious layer may comprise a multi-layered polyethylene film, wherein at least one layer of the multi-layered polyethylene film includes ground nylon for puncture and abrasion resistance. The multi-layered polyethylene film may include additives selected from the group consisting of soil gas prohibitors, UV protection additives, antimicrobial additives, and fire retardant additives.

The foregoing general description of the illustrative embodiments and the following detailed description thereof are merely exemplary aspects of the teachings of this disclosure and are not restrictive.

The assembly may further include a tail section extending from a bottom portion of the assembly. This tail section may be configured to transition from a vertical orientation along the foundation wall to a horizontal orientation along a floor surface and engage with a floor covering to provide a continuous moisture barrier.

According to another aspect of the present disclosure, a vapor barrier and insulation system for a foundation wall is provided. The system may include a non-woven fibrous outer layer configured to engage a vertical foundation surface, a vapor barrier layer adjacent to the non-woven fibrous outer layer, at least one foam insulation layer adjacent to the vapor barrier layer, a reflective layer adjacent to the at least one foam insulation layer, an outer cover layer secured to the vapor barrier layer and enclosing the at least one foam insulation layer and the reflective layer, and at least one spacer disposed between the reflective layer and the outer cover layer to maintain an air gap.

In some implementations, the at least one foam insulation layer may comprise a first foam insulation section adjacent to the vapor barrier layer, a second foam insulation section, and a divider section separating the first and second foam insulation sections. The foam insulation sections may include a series of grooves and ridges that form continuous insulation cavities extending vertically through the foam insulation sections when aligned.

The outer cover layer may comprise a breathable material that allows water vapor to pass through while preventing liquid water penetration. An insert slot may be formed in a top portion of the outer cover layer, configured to allow insertion of additional components after initial installation. A slot cover, which may comprise a vapor barrier tape, may be provided to seal the insert slot when not in use.

In some aspects, the at least one spacer may comprise a flexible material configured to compress or bend during installation while maintaining the air gap. The at least one foam insulation layer may comprise a flexible closed cell foam material that allows the system to be rolled up for transportation and storage.

The reflective layer may comprise a metallic foil configured to reflect radiant heat. The system may further include a tail section extending from a bottom portion of the system, configured to transition from a vertical orientation along the foundation wall to a horizontal orientation along a floor surface.

### BRIEF DESCRIPTION OF FIGURES

The system designed to carry out the invention will hereinafter be described, together with other features thereof. Non-limiting and non-exhaustive examples are described with reference to the following figures. The invention will be more readily understood from a reading of the following specification and by reference to the accompanying drawings forming a part thereof, wherein an example of the invention is shown and wherein:

FIGS. 1a, 1b, and 1c illustrate elevation views of a vapor barrier and insulation system, according to aspects of the present disclosure.

FIG. 2 depicts a rolled configuration of the vapor barrier and insulation system, according to an embodiment.

FIG. 3 shows a detailed view of a portion of the rolled configuration, according to aspects of the present disclosure.

FIG. 4 illustrates a front perspective view of the vapor barrier and insulation system, according to an embodiment.

FIG. 5 depicts a rear view of the vapor barrier and insulation system, according to aspects of the present disclosure.

FIGS. 6 and 7 show cross-sectional views of the vapor barrier and insulation system mounted on a foundation wall, according to an embodiment.

FIG. 8 illustrates a cross-sectional view of just the vapor barrier mounting system with a tail section, according to aspects of the present disclosure.

FIG. 9 shows a cross-sectional view of an alternative embodiment of the vapor barrier and insulation system mounted on a foundation wall, according to aspects of the present disclosure.

FIG. 10 illustrates a top cross-sectional view of the vapor barrier and insulation system, showing the layered construction and insulation cavities, according to an embodiment.

FIG. 11 depicts a perspective view of the vapor barrier and insulation system, highlighting the insert slot and spacer insertion, according to aspects of the present disclosure.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of example embodiments and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, figures and all reasonable inferences to be drawn therefrom, alone or with consideration of the references incorporated herein.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

The present disclosure relates to a vapor barrier and insulation system for protecting and insulating structures, particularly foundation walls. The system may provide moisture protection and thermal insulation for crawlspaces, basements, and other areas prone to moisture intrusion and temperature fluctuations.

In some cases, the vapor barrier and insulation system may include multiple layers that work together to create an effective barrier against moisture while also providing insulation. The system may comprise a moisture-resistant outer layer, a vapor barrier layer, an insulation layer, and a ventilated cover layer. These components may be arranged in a manner that allows for efficient installation on vertical foundation surfaces.

The vapor barrier and insulation system may be designed to address common issues associated with moisture in crawlspaces and basements, such as mold growth, structural damage, and energy inefficiency. By providing a comprehensive solution for moisture control and insulation, the system may help protect the structural integrity of buildings and improve indoor air quality.

In some cases, the system may be configured for easy installation without the need for extensive mechanical fasteners or adhesives. This may allow for more efficient and less invasive application, particularly in existing structures where minimizing damage to foundation walls may be desirable.

The vapor barrier and insulation system may also incorporate features that allow for moisture drainage and air circulation, which may help prevent the accumulation of moisture within the system itself. These features may contribute to the long-term effectiveness and durability of the installed system.

A typical residential structure often includes a crawlspace underneath the living space that contains vents allowing air to pass into the crawlspace from the exterior of the structure. Moisture can seep into the crawlspace through foundation walls, airflow and from the crawlspace ground floor. Additionally, the airflow from the vents causes the air in the crawlspace to be approximately the same temperature as that of the ambient air in the outside environment. By installing a covering such as a plastic sheet vapor barrier, along foundation walls, foundation piers, and the ground floor, the introduction of moisture into the crawlspace can be reduced and the flow of air upward through the structure better controlled. Additionally, by incorporating an insulation layer with the vapor barrier the temperature differential between the living space of a home and the crawlspace can be further controlled. Further, by combining the plastic vapor barrier with a non-woven synthetic fiber sheet that grabs onto the wall without the need for further mechanical attachments, the vapor barrier and insulation layer can be mounted to a foundation wall without the need for drilling holes to insert mechanical fasteners through the material and into the walls.

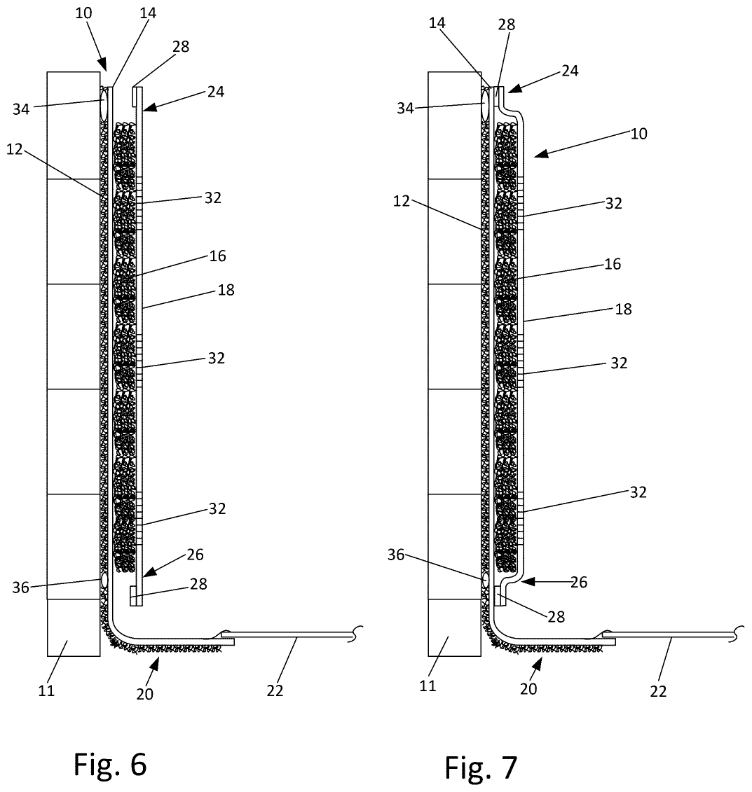

Referring to FIGS. 6 and 7, in one embodiment, foundation walls 11, as well as foundation piers comprise a series of blocks. These blocks are typically constructed from concrete, and can include sand, fine gravel, cinder, ash or other additives based upon the type of block for construction. Blocks can also be made from brick, metal or other materials. In larger structures, the foundations walls and piers may be formed from poured concrete into a form that shapes the foundations walls and piers. In the illustrated embodiment, foundation walls 11 are concrete block. The vapor barrier and insulation system of the present invention, designated generally as 10, is applied directly against the foundation walls 11 and held in place without the need for penetrating mechanical anchor connections. Instead, a non-woven fibrous material layer grabs onto the wall surface with sufficient force to hold and maintain the vapor barrier and insulation system in a vertical attachment to the wall 11.

Referring to FIGS. 4-7, an embodiment of the vapor barrier and insulation system 10 is shown to facilitate sealing and insulating the foundation walls 11 of a structure. The system includes a non-woven fibrous outer layer 12 constructed and arranged for grabbing onto and supporting the vapor barrier and insulation system on a vertical foundation surface, such as concrete, brick and the like commonly found in residential and commercial construction. A moisture impervious vapor barrier layer 14 is carried on the non-woven fibrous outer layer 12 opposite the side arranged for engaging the foundation surface. An insulation material 16, for example a fiberglass insulation sheet, is carried by the vapor barrier layer 14 on the side opposite the non-woven fibrous outer layer 12, such that the vapor barrier layer 14 is disposed between the insulation material 16 and the non-woven fibrous outer layer 12. A ventilated cover layer 18 is disposed adjacent to the insulation material 16 which is constructed and arranged to engage with and enclose the insulation material 16 together with vapor barrier layer 14. A tail section 20 comprised of a portion of non-woven fibrous outer layer 12 and moisture impervious vapor barrier layer 14 extends further below the insulation material 16 and ventilated cover layer 18. Tail section 20 extends down the wall and transitions along the ground for engaging with a floor covering 22, such as a ground cover vapor barrier.

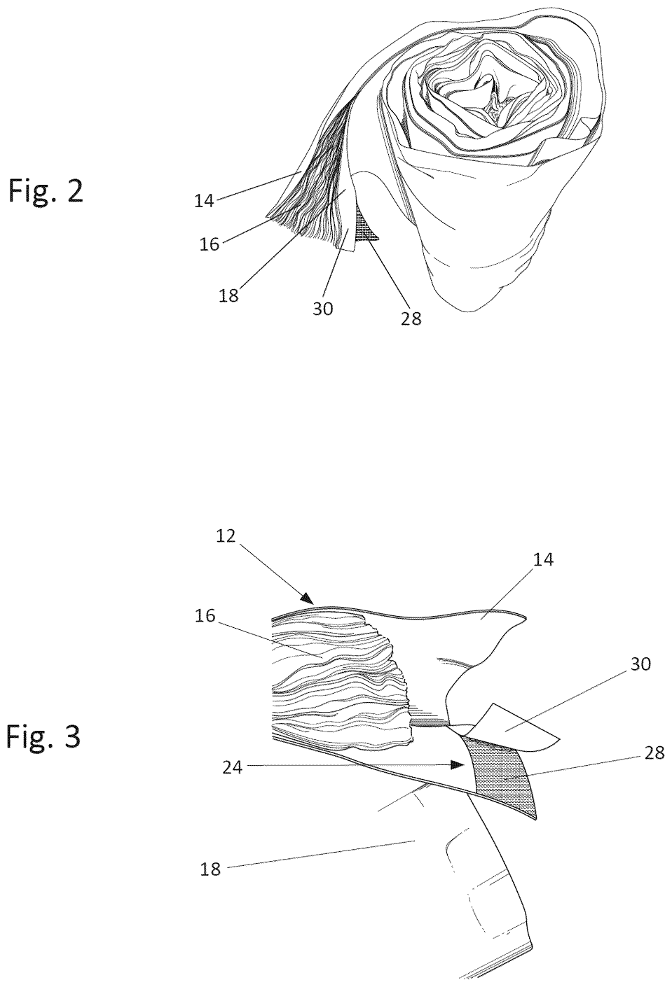

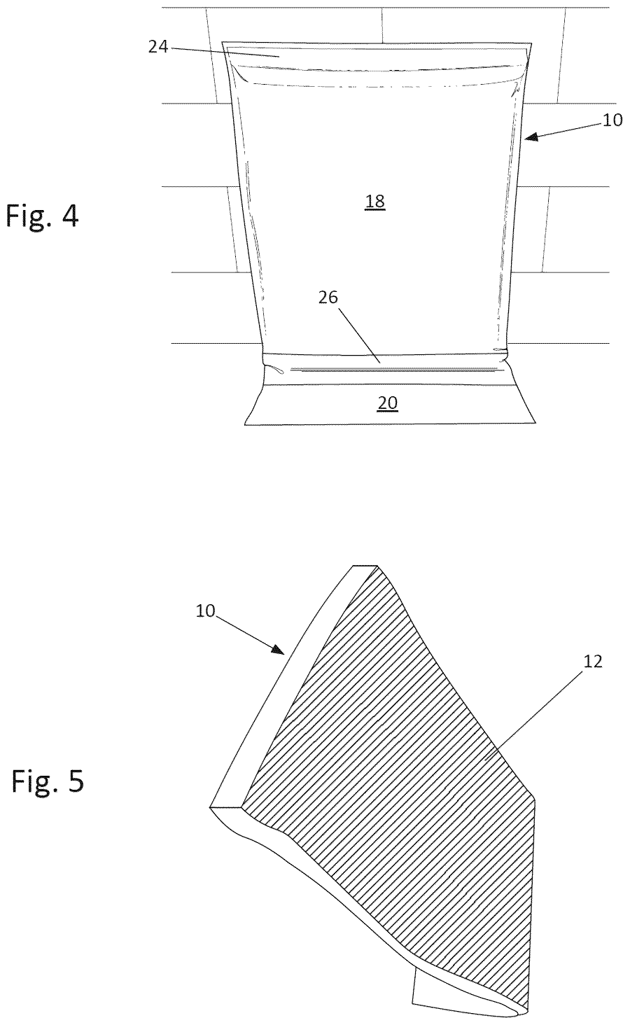

Referring to FIGS. 2, 3, 6 and 7, to facilitate packaging and shipping of the vapor barrier and insulation system 10, a top edge portion 24 and a bottom edge portion 26 of ventilated cover layer 18 are open and expose insulation material 16 prior to installation on a foundation wall. This allows air to escape during compression and rolling of the material for packaging and shipping. Top edge portion 24 and a bottom edge portion 26 include an adhesive layer 28 with a removable cover strip 30. During installation, once the vapor barrier and insulation system 10 is placed on the wall, the cover strip 30 is removed to expose the adhesive layer 28 along both the top edge portion 24 and bottom edge portion 26. The top and bottom edge portions 24, 26 are then pressed against and sealed to vapor barrier layer 14 by adhesive layer 28. Vertical side portions of ventilated cover layer 18 as sealed to vapor barrier layer 14 during manufacturing so that only the top and bottom edge portions 24, 26 are left open and disengaged from vapor barrier layer 14 prior to installation.

Referring to FIGS. 6, 7, and 8, a non-woven fibrous outer layer 12 may be positioned directly against a foundation wall 11. In some cases, the non-woven fibrous outer layer 12 may comprise 100% synthetic fiber extruded and spun, forming a web of random oriented continuous filaments. The non-woven fibrous outer layer 12 may be comprised of 100% polypropylene in certain implementations.

The fibrous outer layer 12 is made with a product that does not promote mold growth and is not biodegradable as it is for use in a wet environment and needs to direct moisture and prevent moisture from entering the conditioned space. In one embodiment, the non-woven fibrous outer layer 12 may be comprised of various synthetic fibers. In some implementations, the synthetic fibers may include materials such as polypropylene, polyester, polyethylene, nylon, polyvinyl chloride, glass, or mixtures thereof. The specific composition of the synthetic fibers may be selected based on factors such as durability, moisture resistance, and adhesion properties to the foundation wall surface. In certain aspects, using a combination of different synthetic fibers may provide enhanced performance characteristics for the non-woven fibrous outer layer 12. The non-woven fibrous outer layer 12 may have a weight ranging from 1.5 oz to 15 oz of fibers. This weight range may provide sufficient material for effective engagement with the foundation wall 11 while maintaining flexibility and ease of installation.

A significant additional benefit of the fibrous outer layer 12 is that is operates as a drainage system for any moisture seeping through or along the foundation walls 11. The structure of the non-woven fibrous outer layer 12, with its web of random oriented continuous filaments, may create pathways for moisture to flow downward along the foundation wall 11. The hydrophobic, loose, not calendared fibers for a web that that will grab the water/moisture on a vertical wall and move it away from and down the foundation walls 11 helping dry the wall while channeling the moisture to the ground or directly into a drain system at the base of the foundation wall, or near the foundation walls. The fibrous outer layer 12 is able to channel large volumes of moisture and water away from walls to the drain or ground. It is beneficial to get this moisture away from the walls as it causes the brick, block, stone and mortar to degrade if constantly wet. The process of transferring the water is done by using a hydrophobic fiber to avoid absorbing the water, while also having air spaces between the fibers that act to channel and move the water aggressively away from the walls. The fibrous outer layer 12 of the system 10 moves water very quickly on a vertical application but also will move the moisture in all directions to dissipate the moisture, such as up and to the sides, as well as downwardly. The fibers of the fibrous web that define outer layer 12 grab water and pull it off the wall and down the channels in the fibers, while a standard plastic vapor barrier simply causes the moisture or water to stay on the wall or run down the wall. By not heating the fibers facing the wall, the arrangement of the present invention leaves larger air pockets between the hydrophobic fibers to increase the capillary effect to draw water away from the wall surface. The water proof/hydrophobic fibers then force movement of the water through air pockets in the fibers until exiting through at the ground level into a drain. The loose, non-heated fibers are used to cling to a foundation wall with its loose fibers. This is helpful to assist attachment to the walls without mechanical attachment/not putting holes into the foundation walls to install the vapor barrier and insulation system 10 of the present invention, or if just using the fibrous outer layer 12 and vapor barrier layer 14 without the additional insulation and ventilated cover layer 18. This product grabs the foundation wall and form a sold vapor barrier on the conditioned side of the space opposite the walls, while allowing the wet, moisture side adjacent the walls to be drained and dry the foundation wall. This system will carry the water/moisture down to the earth or to a drain that ties into a drain mat. This system will pull the water from the wall and move the in the air pockets of the foundation side. This wicking away of the water helps dry the moisture from the wall and extending the life of the mortar and structure. When using on a wall it is important to have the tail section 20 of system 10 to run out on the ground or into a drain, generally around the perimeter of the foundation walls 11. The fibrous outer layer 12 will carry water through the fibers to a specific location until the water can be released. The water will not drip out until it exits at a bottom where the fibrous outer layer 12 touches the ground or other drain element. This drainage function helps prevent moisture accumulation against the foundation wall 11, potentially reducing the risk of water damage and mold growth.

The non-woven fibrous outer layer 12 may engage with the surface of the foundation wall 11 without the need for additional mechanical fasteners. The random orientation of the continuous filaments in the non-woven fibrous outer layer 12 may allow for multiple points of contact with the irregularities in the foundation wall 11 surface, providing a secure attachment. The non-woven loose fibers of fibrous outer layer 12 will grab the wall, brick, stone, block, and mortar to stabilize the vapor barrier and insulation system 10 to a foundation wall 11. This is important when dealing with wet foundation walls because putting more holes in the foundation just causes more moisture to come through the foundation walls. It is standard for contractors to nail or drill holes to attach vapor barriers to these vertical foundation walls, which causes structural damage and more moisture penetration. The fibers of fibrous outer layer 12 act like hook and loop fasteners on the foundation wall, allowing the user to simply adjust/align the vapor barrier and insulation system 10 perfectly on the foundation walls 11 then press the fibrous outer layer 12 against the walls to affix the fibers to grab the uneven surfaces of the foundation walls 11. A bead of adhesive 34 or other sealant/caulk material can be placed on the foundation wall 11 adjacent to a top portion of the fibrous outer layer 12. When the fibrous outer layer 12 is pressed against the wall, the adhesive penetrates through the fibrous outer layer 12 to the vapor barrier layer 14, forming a moisture impervious seal between the wall and vapor barrier layer 14 to prevent moisture from escaping upward along the foundation walls 11. This system will allow the user to put the proper adhesive in place that permanently attaches the vapor barrier and insulation system 10. Another benefit is the adhesive can be applied to any other part of fibrous outer layer 12 to help hold the product in place. Preferably, a continuous bead of adhesive 34 is placed at the top edge to prevent moisture from escaping and other spots/dots 36 of adhesive are applied to secure the position of the vapor barrier and insulation system 10 to prevent accidental separation from the foundation walls 11.

In some applications, it can be useful to heat one side of the fibrous web of fibrous outer layer 12, such as with heavier/denser fibrous web. Heating one side will cause a better cushioning effect, but must have the majority of fibers not heated in order to retain the grabbing capability of the fibers to the foundation walls. If the fibers are heated, the heated side must be attached to the vapor barrier layer 14 side leaving the random loose ended fibers facing the foundation wall 11 to grab/hold onto the surface of the wall.

In some implementations, as shown in FIGS. 4-9 and 11, the non-woven fibrous outer layer 12 may extend beyond the other components of the vapor barrier and insulation system 10 to form a tail section 20. This tail section 20 may transition from the vertical portion of the foundation wall 11 to extend horizontally along a floor surface, providing continuous moisture protection and drainage from the wall to the floor.

Referring to FIGS. 6, 7, and 8, a vapor barrier layer 14 may be positioned adjacent to the non-woven fibrous outer layer 12 in the vapor barrier and insulation system 10. In some cases, the vapor barrier layer 14 may comprise a multilayered moisture impervious sheet. In one embodiment, moisture impervious vapor barrier layer 14, as well as ventilated cover layer 18, can be any water-resistant vapor barrier, reinforced or non-reinforced plastic sheet liner. The moisture impervious sheets used for vapor barrier layer 14 and ventilated cover layer 18 are preferably highly puncture-resistant and may include an antimicrobial property treatment to inhibit mold and bacteria that may cause staining, unpleasant odors, and premature deterioration. Preferably, the vapor barrier layer 14 and ventilated cover layer 18 include a fire-retardant treatment. The fire retardant and antimicrobial properties may be inherent in the specific materials used or may be added by chemical treatment as is known to those skilled in the art. Additionally, vapor barrier layer 14 and ventilated cover layer 18 are both preferably white in color so that it is easier to see whether mold, insects or other items invade the crawlspace after the vapor barrier wrap and other elements of the crawlspace encapsulation system are installed. In one embodiment, vapor barrier layer 14 and ventilated cover layer 18 are selected from the group consisting of plastic film sheeting and rubberized sheeting.

In one embodiment, vapor barrier layer 14 and ventilated cover layer 18 each comprise a solid single layered vinyl sheet ranging in thickness from about 1 mil to 25 mil. The present invention is not to be construed as limited to this range of thickness, which is cited by way of example only. The vapor barrier and insulation system 10 is typically used in a sealed crawlspace or basement with no need for UV protection, however, for a vented crawlspace, vapor barrier layer 14 and ventilated cover layer 18 preferably includes a UV additive or treatment to prevent degradation from UV light exposure over time.

The vapor barrier layer 14 and ventilated cover layer 18 may be formed from a multilayer polyethylene film. This multilayer construction may provide enhanced moisture resistance and durability compared to single-layer films. The thickness of the vapor barrier layer 14 may range from about 1 mil to 25 mil, allowing for flexibility in application while maintaining effective moisture barrier properties.

In some implementations, the vapor barrier layer 14 may incorporate various additives to enhance its performance and protective qualities. These additives may include soil gas prohibitors, which may help prevent the migration of harmful gases from the soil into the protected space. Color or mix additives may also be included in the vapor barrier layer 14, potentially allowing for customization or improved visibility during installation.

The vapor barrier layer 14 may also include UV protection additives. These additives may help prevent degradation of the vapor barrier layer 14 when exposed to ultraviolet light, potentially extending the lifespan of the vapor barrier and insulation system 10 in areas where UV exposure may occur.

Antimicrobial additives may be incorporated into the vapor barrier layer 14 to inhibit the growth of mold, mildew, and bacteria. This feature may contribute to maintaining a healthier environment in the protected space and may help prevent degradation of the vapor barrier layer 14 due to microbial activity.

To enhance durability, the vapor barrier layer 14 may include additives for improved abrasion resistance. These additives may help the vapor barrier layer 14 withstand wear and tear during installation and over the lifetime of the vapor barrier and insulation system 10.

In some cases, fire retardant additives may be incorporated into the vapor barrier layer 14. These additives may help improve the fire resistance of the vapor barrier and insulation system 10, potentially enhancing overall safety in the protected structure.

In one embodiment, the vapor barrier layer 14 comprises a 7 layer blown polyethylene film applied to the fibrous outer layer 12 with the hydrophobic polypropylene fibers formed from a spayed extrusion polymer. As shown in FIGS. 6 and 7, the vapor barrier layer 14 is applied to the fibrous outer layer 12 to prevent moisture from penetrating. The 7 layer blown polyethylene film is reinforcement and is extremely puncture and abrasion resistant through the inclusion of ground nylon in at least one layer. The layers allow for the addition of not just nylons, but soil gas prohibitor, color or mix additives, UV protection, antimicrobial, abrasion resistance, fire retardant, and the like. In one embodiment, attachment of the vapor barrier layer 14 to the fibrous outer layer 12 is a multi-coated process in which a coating of extrusion/tie layer is sprayed on one side of the fibers of the web to seal and cover the fibers with a white coating to prevent it showing thru to the front side. The next step is to laminate a waterproof film over the tie layer, tying all the pieces together. Additionally, layers are then laminated over the waterproof film to add various characteristics as noted above such as, for example, puncture and abrasion resistance, UV protection, antimicrobial, and a fire-retardant layer.

The vapor barrier layer 14 may be attached to the non-woven fibrous outer layer 12, forming a composite structure. This attachment may create a continuous moisture barrier from the foundation wall 11 through the tail section 20 and onto the floor surface, as shown in FIGS. 6-10.

Referring to FIGS. 6 and 7, the vapor barrier and insulation system 10 may include an insulation material 16. In some cases, the insulation material 16 may be positioned adjacent to the vapor barrier layer 14, on the side opposite the non-woven fibrous outer layer 12. The insulation material 16 may be arranged such that the vapor barrier layer 14 is disposed between the insulation material 16 and the non-woven fibrous outer layer 12.

The insulation material 16 may comprise various types of insulating substances. In some implementations, the insulation material 16 may be a fiberglass insulation sheet. Fiberglass insulation may provide effective thermal resistance while being relatively lightweight and easy to install.

In some cases, the insulation material 16 may be composed of other insulating materials such as mineral wool, cellulose, or foam-based products. The specific composition of the insulation material 16 may be selected based on factors such as the desired thermal performance, moisture resistance, and fire safety requirements.

The thermal properties of the insulation material 16 may be characterized by its R-value, which measures thermal resistance. In some implementations, the R-value of the insulation material 16 may be selected to meet local building codes or energy efficiency standards for foundation insulation.

The insulation material 16 may extend vertically along the foundation wall 11 together with the vapor barrier 14, providing a continuous layer of thermal insulation and moisture protection. In some cases, the insulation material 16 may not extend into the tail section 20 of the vapor barrier and insulation system 10, allowing the tail section 20 to maintain flexibility for transitioning from the vertical wall to the horizontal floor surface.

The inclusion of the insulation material 16 in the vapor barrier and insulation system 10 may help control the temperature differential between the protected space (such as a crawlspace or basement) and the living areas of the structure above. By reducing heat transfer through the foundation walls, the insulation material 16 may contribute to improved energy efficiency and more stable interior temperatures.

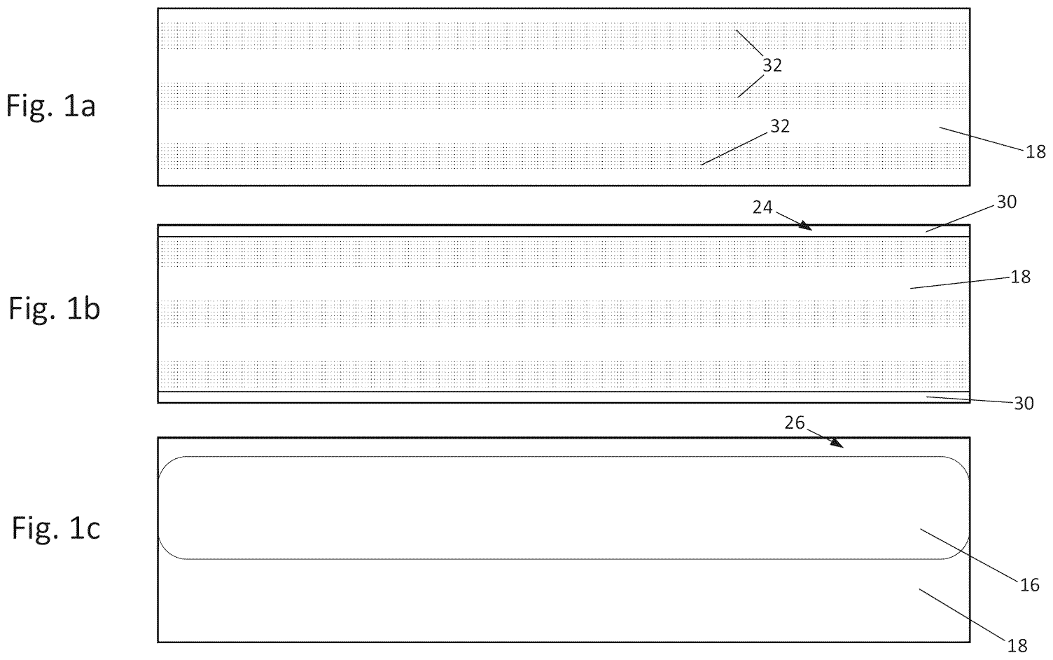

Referring to FIGS. 1a, 1b, 1c, 6, and 7, the vapor barrier and insulation system 10 may include a ventilated cover layer 18. In some cases, the ventilated cover layer 18 may be disposed adjacent to the insulation material 16. The ventilated cover layer 18 may be constructed and arranged to engage with and enclose the insulation material 16 together with the vapor barrier layer 14.

The ventilated cover layer 18 may include a series of perforations 32 distributed across its surface, as shown in FIG. 1a. With further reference to FIGS. 6 and 7, these perforations 32 may allow airflow between the insulation material 16 and the exterior of the ventilated cover layer 18. In some implementations, the perforations 32 may help prevent moisture accumulation within the vapor barrier and insulation system 10 by allowing air circulation. This also allow for any moisture that does accumulate in the insulation material after installation to escape into the surrounding space, such as following a flooding event.

As illustrated in FIGS. 6 and 7, the ventilated cover layer 18 may include a top edge portion 24 and a bottom edge portion 26. These edge portions may be designed to facilitate sealing of the vapor barrier and insulation system 10 during installation. In some cases, the top edge portion 24 and the bottom edge portion 26 may include an adhesive layer 28.

Referring to FIGS. 1a, 1b, and 1c, a removable cover strip 30 may be provided to protect the adhesive layer 28 prior to installation. The removable cover strip 30 may be peeled away to expose the adhesive layer 28 when the vapor barrier and insulation system 10 is ready to be sealed.

In some implementations, as shown in FIGS. 6 and 7, the ventilated cover layer 18 may not extend into the tail section 20 of the vapor barrier and insulation system 10. This configuration may allow the tail section 20 to maintain flexibility for transitioning from the vertical foundation wall 11 to a horizontal floor surface.

The ventilated cover layer 18 may be composed of a material that provides durability and resistance to moisture. In some cases, the ventilated cover layer 18 may be a water-resistant plastic sheet. The specific composition of the ventilated cover layer 18 may be selected based on factors such as moisture resistance, durability, and compatibility with the other components of the vapor barrier and insulation system 10.

Referring to FIGS. 6, 7, and 8, the vapor barrier and insulation system 10 may include a tail section 20. In some cases, the tail section 20 may be comprised of a portion of the non-woven fibrous outer layer 12 and the vapor barrier layer 14 which extends below the insulation material 16 and the ventilated cover layer 18.

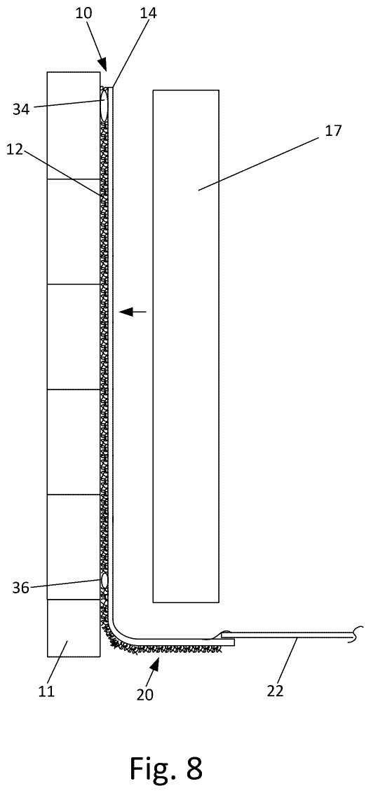

The tail section 20 may be designed to extend down the foundation wall 11 and transition along the ground. In some implementations, as shown in FIG. 8, the tail section 20 may engage with a floor covering 22. The floor covering 22 may be a ground cover vapor barrier or other moisture-resistant material applied to the floor surface of the protected space.

The structure of the tail section 20 may allow for continuous moisture protection from the vertical foundation wall 11 to the horizontal floor surface. In some cases, the non-woven fibrous outer layer 12 and the vapor barrier layer 14 may extend continuously through the tail section 20, maintaining their respective functions of moisture drainage and vapor barrier protection.

The tail section 20 may not include the insulation material 16 or the ventilated cover layer 18. This configuration may allow the tail section 20 to maintain flexibility for transitioning from the vertical foundation wall 11 to the horizontal floor surface. The absence of these components in the tail section 20 may also facilitate easier installation and sealing at the junction between the wall and floor.

In some implementations, the length of the tail section 20 may be customized based on the specific dimensions of the installation site. The tail section 20 may be designed to extend a sufficient distance along the ground to ensure proper overlap with the floor covering 22, creating a continuous moisture barrier.

The transition provided by the tail section 20 may help prevent moisture intrusion at the critical junction between the foundation wall 11 and the floor. By maintaining continuity of the non-woven fibrous outer layer 12 and the vapor barrier layer 14 through this transition, the vapor barrier and insulation system 10 may provide comprehensive moisture protection for the entire protected space.

Referring to FIGS. 6, 7, and 8, the vapor barrier and insulation system 10 may be assembled and installed on foundation walls 11 using a specific process. In some cases, the vapor barrier and insulation system 10 may be provided in custom sizes ranging from 1 foot to 12 feet, allowing for flexibility in fitting various foundation wall dimensions. This gives a lot more flexibility than having to cut 4′×8′ foam sheets that must then be glued or otherwise attached on top of a standard vapor barrier placed against he foundation walls. Thus, the system 10 saves a lot of time and waist, as well as providing a custom drain, when fitting the system to a given space. The flexible nature of the system 10 makes it easier to get into tight places than a 4′×8′ insulation board, and much easier to install and seal to the foundation walls.

The assembly process may begin with positioning the non-woven fibrous outer layer 12 against the foundation wall 11. The vapor barrier layer 14 may be pre-attached to the non-woven fibrous outer layer 12, forming a composite structure. In some implementations, the insulation material 16 may be positioned adjacent to the vapor barrier layer 14, on the side opposite the non-woven fibrous outer layer 12.

The ventilated cover layer 18 may be arranged to enclose the insulation material 16 and vapor barrier layer 14. In some cases, the ventilated cover layer 18 may include a top edge portion 24 and a bottom edge portion 26, each containing an adhesive layer 28 protected by a removable cover strip 30.

During installation, an adhesive bead 34 may be applied on the foundation wall 11 adjacent to a top portion of the non-woven fibrous outer layer 12. When the non-woven fibrous outer layer 12 is pressed against the foundation wall 11, the adhesive bead 34 may form a moisture impervious seal between the wall and the vapor barrier layer 14. This seal may help prevent moisture from escaping upward along the foundation walls 11.

In some implementations, additional adhesive spots 36 may be applied at intervals along the vapor barrier and insulation system 10. The adhesive spots 36 may help secure the position of the vapor barrier and insulation system 10 and prevent accidental separation from the foundation walls 11.

To complete the installation, the removable cover strip 30 may be removed from the top edge portion 24 and the bottom edge portion 26 of the ventilated cover layer 18. The exposed adhesive layer 28 may then be pressed against and sealed to the vapor barrier layer 14, enclosing the insulation material 16.

The tail section 20, comprised of portions of the non-woven fibrous outer layer 12 and the vapor barrier layer 14, may extend below the insulation material 16 and the ventilated cover layer 18. In some cases, the tail section 20 may transition from the vertical foundation wall 11 to engage with a floor covering 22 on the horizontal surface, providing continuous moisture protection.

The perforations 32 in the ventilated cover layer 18 may allow for air circulation within the installed system, potentially helping to prevent moisture accumulation. The completed installation may provide a comprehensive moisture barrier and insulation system for the foundation walls 11 without the need for extensive mechanical fasteners.

Referring to FIGS. 6, 7, and 8, the vapor barrier and insulation system 10 may integrate multiple components to provide comprehensive moisture protection, insulation, and drainage for foundation walls 11. The system components may work together to create an effective barrier against moisture intrusion while also offering thermal insulation benefits.

Referring to FIG. 8, in one embodiment the vapor barrier system may comprise only the non-woven fibrous outer layer 12 and the vapor barrier layer 14, providing a simplified yet effective moisture control solution for foundation walls. This configuration may be particularly suitable for applications where thermal insulation is not a primary concern or where space constraints limit the use of thicker assemblies.

The non-woven fibrous outer layer 12 may be positioned directly against the foundation wall 11, utilizing its ability to engage and grab onto the vertical surface without mechanical fasteners. This layer may be composed of hydrophobic polypropylene fibers, which may draw moisture away from the foundation surface through capillary action. The structure of the non-woven fibrous material may create air pockets between the fibers, potentially enhancing the moisture wicking effect and facilitating downward water movement along the wall.

The vapor barrier layer 14 may be applied to the non-woven fibrous outer layer 12 as detailed herein above. This layer may consist of a single layer or multi-layered moisture impervious sheet, such as a polyethylene film. The vapor barrier layer 14 may prevent moisture from penetrating further into the protected space while working in conjunction with the fibrous outer layer to manage moisture.

In this embodiment, the system may still incorporate a tail section 20 comprised of extensions of both the non-woven fibrous outer layer 12 and the vapor barrier layer 14. This tail section 20 may transition from the vertical wall application to a horizontal floor surface, potentially engaging with a floor covering 22 to create a continuous moisture barrier.

The simplified two-layer system may be additionally secured to the foundation wall 11 using an adhesive bead 34 applied near the top of the assembly. Additional adhesive spots 36 may be placed at intervals along the system to ensure proper adhesion to the wall surface.

This configuration may offer advantages in terms of ease of installation, reduced material costs, and a slimmer profile compared to the full insulation system. It may be particularly useful in scenarios where moisture control is the primary concern, such as in certain crawlspace applications or in climates where thermal insulation requirements are less stringent.

In some implementations, as illustrated in FIG. 8, the vapor barrier and insulation system 10 may incorporate a rigid foam board insulation material 17 as an alternative to the flexible insulation material described previously. The foam board insulation 17 may be attached to the vapor barrier layer 14, creating a composite structure that combines moisture protection with thermal insulation.

The foam board insulation 17 may be utilized in various configurations within the vapor barrier and insulation system 10, offering flexibility in design and application. In some implementations, the foam board insulation 17 may be used without the ventilated cover layer 18 or outer cover layer 38, creating a more streamlined assembly.

When used without a cover layer, the foam board insulation 17 may be directly attached to the vapor barrier layer 14, potentially reducing the overall thickness of the system while still providing thermal insulation benefits. This configuration may be suitable for applications where space is limited or where a simpler installation process is desired.

In other cases, the foam board insulation 17 may be incorporated with either the ventilated cover layer 18 or the outer cover layer 38 (detailed herein below), depending on the specific requirements of the installation. The inclusion of a cover layer may provide additional protection for the foam board insulation 17 and may offer benefits such as improved moisture management or enhanced durability.

The choice to use the foam board insulation 17 with or without a cover layer may depend on factors such as local building codes, climate conditions, and the specific moisture control needs of the installation site. In some implementations, the system may be designed to allow for the addition or removal of a cover layer in the field, providing adaptability to different installation scenarios.

When used without a cover layer, the exposed surface of the foam board insulation 17 may be treated or selected to provide adequate resistance to moisture and potential physical damage. In some cases, the foam board insulation 17 may incorporate its own vapor barrier properties, potentially eliminating the need for a separate vapor barrier layer in certain applications.

The versatility of the foam board insulation 17 in terms of its use with or without cover layers may allow for customization of the vapor barrier and insulation system 10 to meet diverse project requirements and performance goals.

The foam board insulation 17 may be positioned adjacent to the vapor barrier layer 14 on the side opposite the non-woven fibrous outer layer 12. In some cases, the foam board insulation 17 may be adhered to the vapor barrier layer 14 using a compatible adhesive, tape or other attachment means that do not compromise the moisture barrier properties of the vapor barrier layer 14.

This configuration may provide enhanced thermal performance in some applications while maintaining the moisture management benefits of the non-woven fibrous outer layer 12 and vapor barrier layer 14. The rigid nature of the foam board insulation 17 may offer additional structural support to the overall system, potentially improving its durability and resistance to physical impacts.

In some aspects, the foam board insulation 17 may be pre-cut to match the dimensions of the vapor barrier layer 14, allowing for efficient installation and minimizing on-site modifications. The thickness of the foam board insulation 17 may be selected based on the desired thermal resistance (R-value) for the specific application.

The attachment of the foam board insulation 17 to the vapor barrier layer 14 may still allow for the inclusion of a tail section 20, which may extend beyond the foam board to maintain flexibility for transitioning from the vertical foundation wall 11 to the horizontal floor surface. This arrangement may provide a comprehensive solution that addresses both moisture control and thermal insulation needs in a single, integrated system.

In some cases, the non-woven fibrous outer layer 12 may serve as the initial point of contact with the foundation wall 11. The structure of the non-woven fibrous outer layer 12 may allow for engagement with the wall surface without the need for mechanical fasteners. Additionally, the non-woven fibrous outer layer 12 may function as a drainage plane, channeling moisture downward along the foundation wall 11.

The vapor barrier layer 14, positioned adjacent to the non-woven fibrous outer layer 12, may provide a moisture-impervious barrier. In some implementations, the vapor barrier layer 14 may work in conjunction with the non-woven fibrous outer layer 12 to manage moisture. While the non-woven fibrous outer layer 12 may facilitate drainage, the vapor barrier layer 14 may prevent moisture from penetrating further into the system.

The insulation material 16 may be situated next to the vapor barrier layer 14, on the side opposite the non-woven fibrous outer layer 12. In some cases, the insulation material 16 may provide thermal resistance, helping to control temperature differentials between the protected space and the exterior environment. The positioning of the insulation material 16 behind the vapor barrier layer 14 may help keep the insulation dry, potentially maintaining its thermal performance over time.

The ventilated cover layer 18 may enclose the insulation material 16 and vapor barrier layer 14. In some implementations, the perforations 32 in the ventilated cover layer 18 may allow for air circulation within the system. This ventilation feature may help prevent moisture accumulation within the insulation material 16, potentially enhancing the long-term performance of the vapor barrier and insulation system 10.

The tail section 20, comprised of portions of the non-woven fibrous outer layer 12 and the vapor barrier layer 14, may extend below the insulation material 16 and the ventilated cover layer 18. In some cases, the tail section 20 may provide a continuous moisture barrier from the vertical foundation wall 11 to the horizontal floor surface, potentially preventing moisture intrusion at this critical junction.

The integration of these components may result in a system that addresses multiple aspects of foundation wall protection. The non-woven fibrous outer layer 12 and vapor barrier layer 14 may work together to manage moisture, while the insulation material 16 may provide thermal benefits. The ventilated cover layer 18 may help maintain the integrity of the insulation material 16, and the tail section 20 may ensure continuity of protection.

In some implementations, the adhesive bead 34 applied at the top of the system and the adhesive spots 36 along the length may help secure the vapor barrier and insulation system 10 to the foundation wall 11. The adhesive layer 28 on the top edge portion 24 and bottom edge portion 26 of the ventilated cover layer 18 may allow for sealing of the system components, potentially enhancing overall moisture protection.

The floor covering 22, which may engage with the tail section 20, may extend the moisture protection to the floor surface of the protected space. This integration may create a comprehensive moisture management system from the foundation walls 11 to the floor.

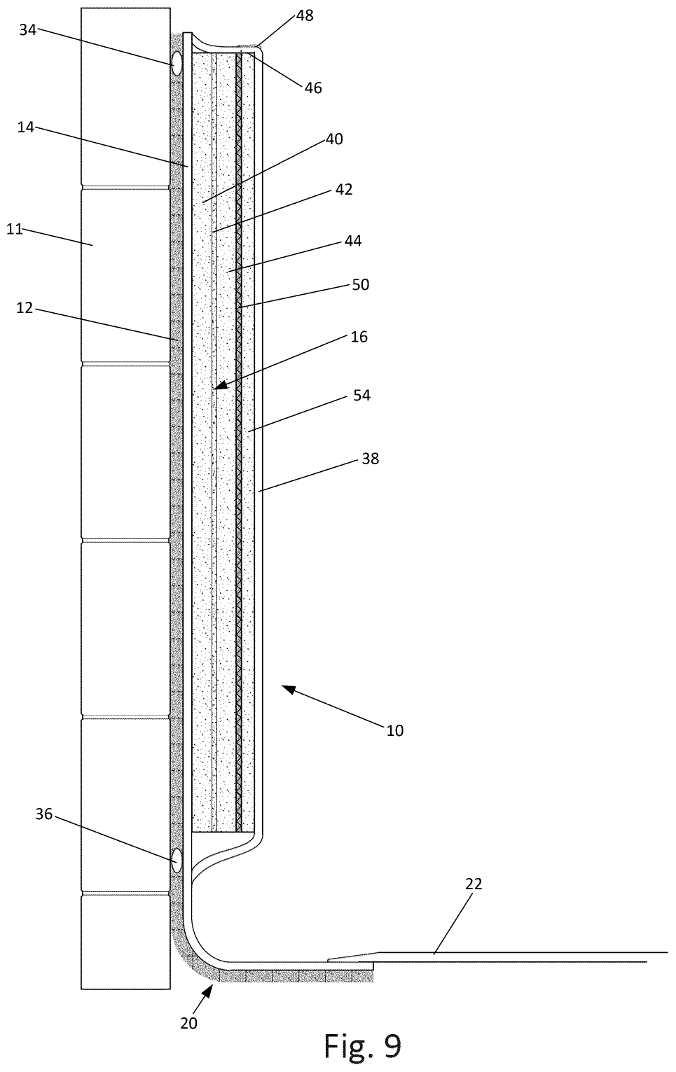

Referring to FIG. 9, an alternative embodiment of the vapor barrier and insulation system 10 is shown mounted on a foundation wall 11. This embodiment may include additional layers and components to enhance insulation performance and moisture management.

The system may include a non-woven fibrous outer layer 12 positioned directly against the foundation wall 11, followed by a vapor barrier layer 14. An insulation material 16 may be situated adjacent to the vapor barrier layer 14. In this configuration, an outer cover layer 38 may enclose the insulation components, potentially replacing or supplementing the ventilated cover layer 18 described in previous embodiments.

In this illustrated embodiment, the outer cover layer 38 is pre-sealed directly to the vapor barrier layer 14, unlike the prior embodiment detailed above. This configuration may provide a more integrated and potentially more moisture-resistant assembly. By pre-sealing these layers, the system may offer enhanced protection against moisture intrusion and air infiltration.

In some implementations, the pre-sealing process may involve heat sealing, adhesive bonding, or other joining methods that create a strong, continuous seal between the outer cover layer 38 and the vapor barrier layer 14. This pre-sealed configuration may eliminate the need for on-site sealing of these layers during installation, potentially simplifying the installation process and reducing the risk of improper sealing.

The pre-sealed outer cover layer 38 and vapor barrier layer 14 may form a composite structure that encapsulates the insulation material 16. This arrangement may help protect the insulation from moisture and contaminants, potentially extending its effective lifespan and maintaining its thermal performance over time.

In some cases, the pre-sealed configuration may allow for the creation of compartments or channels within the system. These features may facilitate drainage or air circulation, depending on the specific design requirements of the installation environment.

The outer cover layer 38, when pre-sealed to the vapor barrier layer 14, may provide a more robust exterior surface for the system. This may enhance the overall durability of the vapor barrier and insulation system 10, potentially improving its resistance to physical damage during and after installation.

While the pre-sealed configuration may offer certain advantages, it may also require careful consideration during the manufacturing process to ensure proper alignment and integration of all system components. The design may need to account for factors such as thermal expansion, flexibility, and ease of handling during transportation and installation.

The outer cover layer 38 may be constructed from a variety of materials to provide moisture management and protection for the insulation components. In some implementations, the outer cover layer 38 may include perforations 32 similar to those found in the ventilated cover layer 18, allowing for air circulation within the system. However, in other aspects, the outer cover layer 38 may be composed of a breathable material that does not require perforations.

This breathable material may allow water vapor to pass through while preventing liquid water penetration. Such materials may utilize microporous structures or hydrophilic properties to achieve this selective permeability. In some cases, the outer cover layer 38 may be constructed from a vapor barrier material similar to those used in building wrap applications. For instance, materials like Tyvek, which is a brand of flashspun high-density polyethylene fibers, may be employed for this purpose.

The use of a breathable, non-perforated material for the outer cover layer 38 may offer several potential benefits. It may provide a continuous barrier against liquid moisture while still allowing the system to “breathe” and release trapped water vapor. This characteristic may help manage moisture levels within the insulation material 16 and other components of the vapor barrier and insulation system 10. Additionally, a non-perforated outer layer may offer enhanced protection against air infiltration, potentially improving the overall energy efficiency of the system.

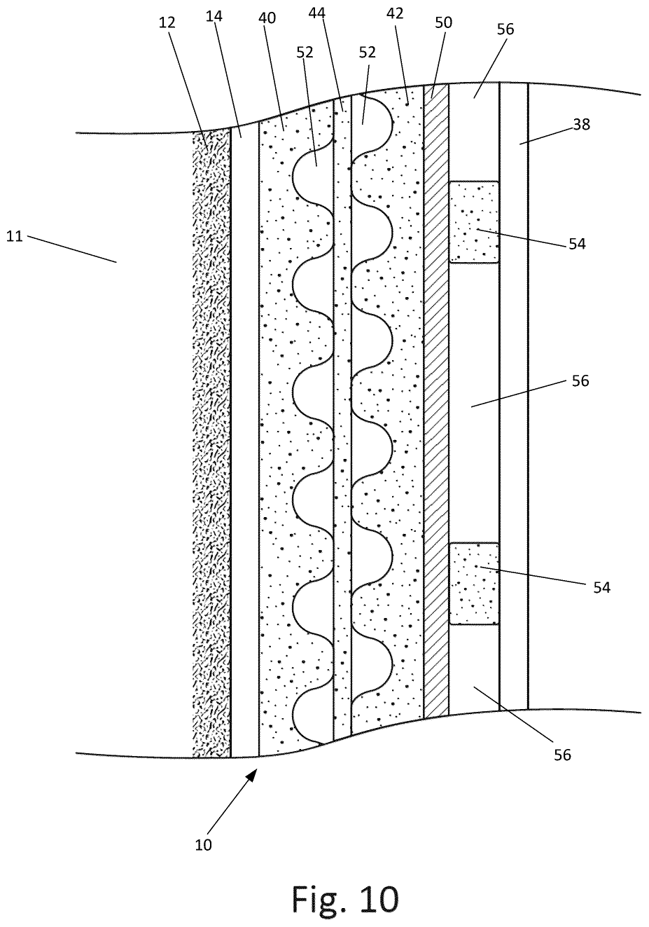

In one embodiment, the insulation material 16 may be an insulation foam type material, as opposed to a fiber glass insulation of the type shown in the embodiments herein above. In the illustrated embodiment of FIGS. 9-11, the insulation material 16 is divided into a first foam insulation section 40 and a second foam insulation section 42, separated by a divider section 44. This arrangement allow for customization of insulation properties and facilitate the creation of air spaces within the system as shown in FIG. 10. In some implementations, the first and second foam insulation sections 40, 42 may be composed of different materials or densities to optimize thermal performance.

In some implementations, the insulation material 16 may only be a single sheet of foam. This configuration may provide a uniform insulation layer throughout the vapor barrier and insulation system 10. The single sheet design may offer advantages in terms of simplicity of installation and consistency of thermal performance across the entire surface area.

The foam sheet may be composed of various materials such as polyurethane, polyisocyanurate, or expanded polystyrene, depending on the specific insulation requirements and environmental conditions. The thickness of the foam sheet may be selected to achieve the desired R-value for the application.

In some cases, using a single sheet of foam for the insulation material 16 may facilitate easier integration with the other components of the system, such as the vapor barrier layer 14 and the outer cover layer 38. This configuration may also potentially reduce the number of seams or joints within the insulation layer, which may help minimize potential pathways for moisture or air infiltration.

The single sheet foam insulation may be designed with specific surface textures or patterns to enhance its performance. For example, the surface facing the vapor barrier layer 14 may include channels or grooves to facilitate drainage of any moisture that may penetrate the outer layers. The opposite surface may be textured to create small air pockets between the insulation and the outer cover layer 38, potentially improving the overall thermal performance of the system.

In some aspects, the first foam insulation section 40 and second foam insulation section 42 may be composed of closed cell foam materials. These closed cell foams may provide flexibility, allowing the vapor barrier and insulation system 10 to be rolled up for transportation and storage. The foam materials may include polyethylene foam or other flexible type foams.

The use of closed cell foam for the insulation sections may offer several potential benefits. Closed cell foam structures may provide enhanced moisture resistance compared to open cell foams, which may be advantageous in foundation wall applications where moisture management is a key concern. Additionally, the closed cell structure may contribute to improved thermal insulation properties.

In some implementations, the flexibility of the closed cell foam may allow for easier installation of the vapor barrier and insulation system 10, particularly in areas with limited access or irregular foundation wall surfaces. The ability to roll up the system may also facilitate more efficient shipping and on-site handling.

The polyethylene foam or other flexible foams used in the insulation sections may be selected based on factors such as thermal performance, moisture resistance, and compatibility with other components of the vapor barrier and insulation system 10. In some cases, the specific foam composition may be tailored to meet particular climate requirements or building code specifications.

In some implementations, alternative flexible foam types may be used for the insulation sections of the vapor barrier and insulation system 10. These alternative foam materials may offer various properties that can be advantageous in different installation scenarios or environmental conditions.

Polyurethane foam may be utilized in some aspects of the system. This foam type may offer excellent thermal insulation properties and can be formulated to provide varying degrees of flexibility. In some cases, polyurethane foam may be engineered to have both closed-cell and open-cell structures within the same material, potentially allowing for customized performance characteristics.

Elastomeric foam, such as those based on synthetic rubber compounds, may be employed in certain implementations. These foams may offer high flexibility and resilience, which can be beneficial in applications where the insulation material needs to conform to irregular surfaces or accommodate structural movement. Some elastomeric foams may also provide enhanced sound dampening properties.

In some cases, polypropylene foam may be used as an alternative to polyethylene foam. Polypropylene foam may offer similar flexibility and moisture resistance to polyethylene, but with potentially higher temperature resistance in certain formulations. This characteristic may be beneficial in environments subject to greater temperature fluctuations.

Ethylene vinyl acetate (EVA) foam may be incorporated into the insulation sections in some implementations. EVA foam may provide a combination of flexibility, durability, and chemical resistance. Its closed-cell structure may contribute to moisture resistance while maintaining good thermal insulation properties.

In certain aspects, bio-based foams derived from renewable resources may be utilized. These may include foams made from materials such as soy, corn, or other plant-based polymers. Bio-based foams may offer environmental benefits and may be formulated to provide comparable performance to traditional petroleum-based foams.

Aerogel-infused flexible foams may be employed in some high-performance applications. These composite materials may combine the flexibility of traditional foams with the superior insulating properties of aerogels, potentially allowing for thinner insulation layers with equivalent thermal performance.

The selection of foam type may depend on factors such as local climate conditions, specific insulation requirements, cost considerations, and compatibility with other system components. In some implementations, a combination of different foam types may be used within the same vapor barrier and insulation system 10 to optimize performance across various areas of the installation.

The flexibility of the foam insulation sections may also contribute to the overall adaptability of the vapor barrier and insulation system 10. This characteristic may allow the system to conform more closely to variations in the foundation wall surface, potentially improving its effectiveness as a moisture barrier and insulation solution.

An insert slot 46 may be formed in a top portion of the outer cover layer 38. This slot may allow for the insertion of additional components, such as spacers 54 described herein below, or other such adjustments to the system after initial installation. A slot cover 48 may be provided to seal the insert slot 46 when not in use, maintaining the integrity of the moisture barrier.

The slot cover 48 may be a vapor barrier tape. This tape may be designed to provide a moisture-resistant seal when applied over the insert slot 46. In some implementations, the vapor barrier tape may be composed of materials that are compatible with the outer cover layer 38 and offer similar moisture protection properties. The tape may have an adhesive backing that allows for secure attachment to the outer cover layer 38, creating a continuous barrier around the insert slot 46.

In certain aspects, the vapor barrier tape used as the slot cover 48 may be removable and reusable, allowing for multiple access events to the insert slot 46 over the lifespan of the vapor barrier and insulation system 10. The tape may be designed to maintain its sealing properties even after repeated applications and removals, ensuring the ongoing integrity of the moisture barrier.

The vapor barrier tape may come in various widths and lengths to accommodate different sizes of insert slots 46. In some cases, the tape may be cut to size on-site to provide a custom fit for each specific application. The tape may also be available in different colors or patterns to match or complement the appearance of the outer cover layer 38, potentially improving the aesthetic integration of the slot cover 48 with the overall system.

The system may incorporate a reflective layer 50, which may enhance the insulation properties by reflecting radiant heat. A spacer 54 may be disposed between the reflective layer 50 and the outer cover layer 38, creating an air gap that may further improve insulation performance.

The reflective layer 50 may be composed of various materials with high reflectivity properties. In some implementations, the reflective layer 50 may comprise a metallic foil, such as aluminum foil. Alternatively, the reflective layer 50 may include other reflective materials or coatings that can effectively reflect radiant heat. The choice of material for the reflective layer 50 may depend on factors such as durability, cost-effectiveness, and overall thermal performance requirements of the vapor barrier and insulation system 10. In some cases, the reflective layer 50 may be a composite material that combines reflective properties with additional beneficial characteristics such as moisture resistance or structural stability.

As with previous embodiments, a tail section 20 may extend from the bottom of the system, transitioning to engage with a floor covering 22. An adhesive bead 34 near the top of the system and adhesive spots 36 along its length may secure the assembly to the foundation wall 11 for a more secure installation.

Referring to FIG. 10, a top cross-sectional view of the vapor barrier and insulation system 10 mounted on a foundation wall 11 is illustrated. This view may provide additional insight into the layered construction and internal components of the system.

The non-woven fibrous outer layer 12 may be seen in direct contact with the foundation wall 11, followed by the vapor barrier layer 14. The outer cover layer 38 may form the exterior facing surface of the system. Between these layers, the first foam insulation section 40 and second foam insulation section 42 may be visible, separated by the divider section 44.

In some implementations, the first and second foam insulation sections 40, 42 may feature a series of grooves and ridges facing the divider section 44. These features may create insulation cavities 52 that extend vertically through the system's construction. The insulation cavities 52 may serve multiple purposes, such as allowing for improved compression of the insulation material during packaging and transportation, or creating additional air spaces to enhance insulation performance.

In some implementations, the vapor barrier and insulation system 10 may incorporate multiple foam layers without the use of insulation cavities or a divider section. This configuration may provide a continuous insulation barrier while maintaining flexibility and ease of installation.

The system may include two or more foam insulation layers arranged in a stacked configuration between the vapor barrier layer 14 and the outer cover layer 38. These foam layers may be composed of the same or different materials or densities to optimize thermal performance and moisture resistance. For example, a denser closed-cell foam layer may be positioned adjacent to the vapor barrier layer 14 to enhance moisture protection, while a more flexible open-cell foam layer may be placed closer to the outer cover layer 38 to improve conformability to irregular foundation surfaces.

The multiple foam layers may be adhered to each other using compatible adhesives or may be thermally bonded during the manufacturing process. This layered approach may allow for customization of insulation properties throughout the thickness of the system, potentially addressing specific thermal and moisture management requirements for different climate zones or building codes.

In some cases, the interfaces between the foam layers may create natural air pockets that can contribute to the overall insulation value of the system. These microscopic air spaces may enhance the thermal performance without the need for engineered insulation cavities.

In the illustrated embodiment, divider section 44 is needed to maintain aid pockets 52. However, in other arrangements, the absence of a divider section may result in a more uniform and continuous insulation profile if air pockets 52 are not desired. This may potentially reduce thermal bridging and simplify the manufacturing process. The multiple foam layer configuration may still allow for the system to be rolled up for transportation and storage, preferably with each layer flexing independently to some degree within the overall structure of the vapor barrier and insulation system 10.

In the illustrated embodiment, the reflective layer 50 may be positioned between the second foam insulation section 42 and the outer cover layer 38. Spacers 54 may maintain an air gap 56 between the reflective layer 50 and the outer cover layer 38. This air gap 56 may extend vertically through the system's construction, potentially improving the overall insulation value of the assembly.

In some implementations, the spacers 54 may take various forms beyond the rectangular strips shown in the illustrations. For example, the spacers 54 may be round in shape, resembling cylindrical rods or dowels. In other aspects, the spacers 54 may comprise sections of tubing, which could be hollow or solid, depending on the specific requirements of the installation.

The shape and material of the spacers 54 may be selected to optimize their performance within the vapor barrier and insulation system 10. Round spacers or tubular sections may provide advantages in certain installations, such as more uniform distribution of pressure or improved air circulation within the air gap 56.

In some cases, the spacers 54 may be constructed from flexible materials to facilitate installation in tight or irregularly shaped spaces. This flexibility may allow the vapor barrier and insulation system 10 to conform more closely to uneven foundation surfaces or accommodate obstacles such as pipes or conduits that may be present on the foundation wall 11.

Flexible spacers 54 may be made from materials such as foam, rubber, or pliable plastics. These materials may allow the spacers to compress or bend as needed during installation while still maintaining their ability to create and preserve the air gap 56 between the reflective layer 50 and the outer cover layer 38.

In some implementations, the flexible nature of the spacers 54 may also contribute to the overall adaptability of the vapor barrier and insulation system 10. This characteristic may allow for easier rolling or folding of the system for transportation and storage, potentially simplifying logistics and on-site handling.

The specific design and material selection for the spacers 54 may be tailored to meet particular installation requirements, climate conditions, or building codes. In some aspects, different types of spacers may be used within the same installation to address varying needs across different sections of the foundation wall 11.

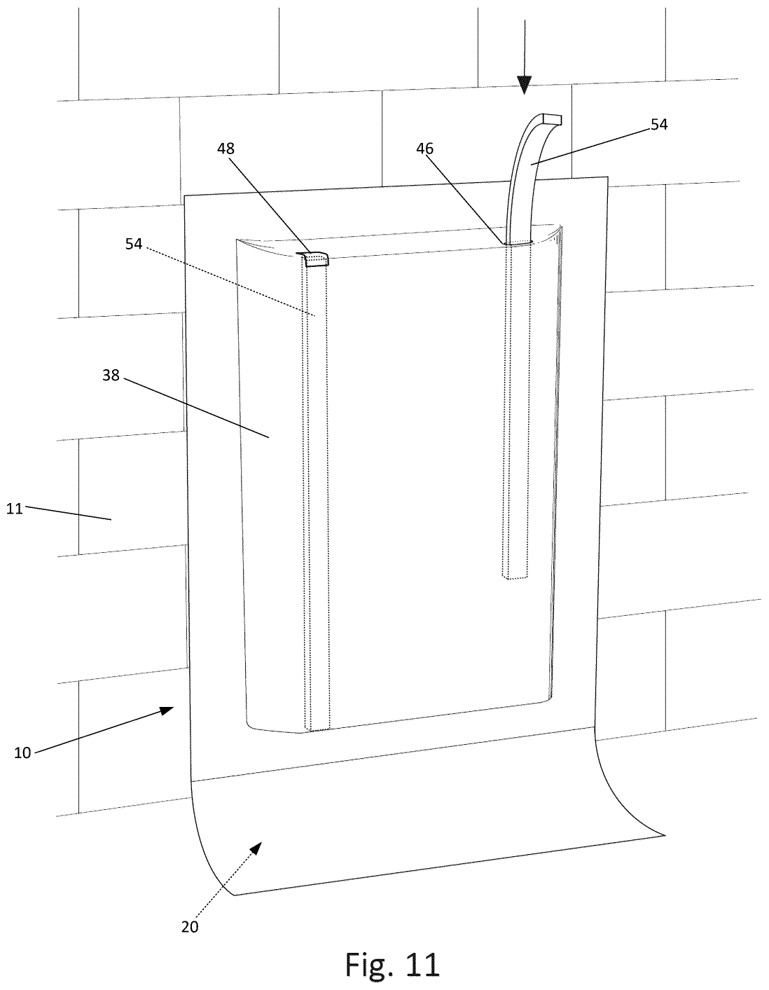

Referring to FIG. 11, a perspective view of the vapor barrier and insulation system 10 mounted on a foundation wall 11 is shown, highlighting the insert slot 46 and spacer 54 insertion process. This view may illustrate how the system can be adjusted or customized after initial installation to maintain a spacing between reflective layer 50 and outer cover layer 38.

The outer cover layer 38 may form the exterior facing surface of the system, with the insert slot 46 visible in an upper portion. The slot cover 48 may be provided to seal the insert slot 46 when not in use. The figure shows one spacer 54 fully inserted through the insert slot 46, while another spacer is in the process of being inserted in a downward direction.

This configuration may allow for adjustments to the internal spacing of the system, potentially optimizing its performance based on specific environmental conditions or changing requirements. The ability to insert or adjust spacers 54 through the insert slot 46 may provide flexibility in maintaining the desired air gap between layers, which may be particularly beneficial for the performance of the reflective layer 50.

The tail section 20 may be visible extending from the bottom of the vapor barrier and insulation system 10, transitioning from the vertical orientation of the wall to a horizontal orientation where it meets the ground surface. This continuous barrier from the foundation wall 11 through the tail section 20 may provide comprehensive moisture protection for the entire installation area.

The layered construction of this vapor barrier and insulation system 10 allow for the layers to contour with and deal with irregularities on the installation surface of the walls while also drawing water from the foundation wall and not letting the moisture back into the conditioned space. This system 10 is very beneficial for foundation walls that do not need more holes drilled or shot into them. It is particularly helpful in replacing the hanging of a foam board or bat insulation glued to a standard vapor barrier on the vertical walls. The fibers are effective enough to hold the weight of the vapor barrier and insulation layers vertically. Adhesive can be used for more permanent installation and to prevent moisture from moving up the wall surface as detailed herein above. The tail section 20 extends out onto the ground to drain moisture and attach to any ground vapor barrier. The ground vapor barrier could be the same as for the wall, just becomes a ground drain mat. The system can be pre-made to virtually any size and is well suited for installation on concrete foundation walls. A benefit of this system 10 is that if the materials needs to be replaced, such as from damage caused by rodents, flooding, remediation, updated codes, the system is easily detached from the foundation walls and leaves a clean undamaged wall behind. The fibers grabbing the walls eliminate the need for large nails or other mechanical fasteners causing holes and potentially breaking the foundation. When disassembled you are back to the original walls. This system is also much easier and less expensive to ship than standard foam board insulation. Foam board insulation is easily damaged in shipping and thus is not available to all markets and contractors because of these issues, problems not found in the present invention.

By combining drainage, vapor barrier, insulation, and ventilation functions, the vapor barrier and insulation system 10 may provide a multi-faceted approach to foundation wall protection. The integrated design may allow for installation without extensive mechanical fasteners, potentially simplifying the application process while maintaining effective moisture control and insulation performance.

A number of implementations have been described. Nevertheless, it will be understood that various modifications may be made without departing from the spirit and scope of the disclosure. While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A vapor barrier and insulation system for a foundation wall, comprising:
a non-woven fibrous outer layer configured to engage and grab onto a vertical foundation surface;
a moisture impervious vapor barrier layer carried on the non-woven fibrous outer layer opposite a side arranged for engaging the foundation surface;
an insulation material carried by the vapor barrier layer on a side opposite the non-woven fibrous outer layer such that the vapor barrier layer is disposed between the insulation material and the non-woven fibrous outer layer;
a ventilated cover layer disposed adjacent to the insulation material and constructed to enclose the insulation material together with the vapor barrier layer; and
a tail section comprised of a portion of the non-woven fibrous outer layer and the moisture impervious vapor barrier layer extending below the insulation material and the ventilated cover layer.

2. The vapor barrier and insulation system of claim 1, wherein the non-woven fibrous outer layer comprises hydrophobic polypropylene fibers.

3. The vapor barrier and insulation system of claim 2, wherein the hydrophobic polypropylene fibers are configured to draw moisture away from the foundation surface.

4. The vapor barrier and insulation system of claim 1, wherein the moisture impervious vapor barrier layer comprises a multi-layered polyethylene film.

5. The vapor barrier and insulation system of claim 4, wherein at least one layer of the multi-layered polyethylene film includes ground nylon for puncture and abrasion resistance.

6. The vapor barrier and insulation system of claim 1, wherein the ventilated cover layer includes a series of perforations to allow airflow between the insulation material and exterior of the ventilated cover layer.

7. The vapor barrier and insulation system of claim 6, wherein the ventilated cover layer comprises a top edge portion and a bottom edge portion, each including an adhesive layer for sealing the ventilated cover layer to the vapor barrier layer.

8. A vapor barrier system for a foundation wall, comprising:
a non-woven fibrous outer layer of hydrophobic fibers for engaging a vertical foundation surface and drawing moisture away from the foundation surface; and
a multi-layered moisture impervious vapor barrier sheet carried on the non-woven fibrous outer layer opposite a side arranged for engaging the foundation surface;
wherein the vapor barrier sheet includes a polyethylene film applied to the fibrous outer layer; and
wherein at least one layer of the vapor barrier sheet includes ground nylon for puncture and abrasion resistance.

9. The vapor barrier system of claim 8, wherein the hydrophobic fibers comprise polypropylene fibers.

10. The vapor barrier system of claim 9, wherein the polypropylene fibers are configured to form air pockets between the fibers to increase capillary effect for drawing water away from the foundation surface.

11. The vapor barrier system of claim 8, wherein the multi-layered moisture impervious vapor barrier sheet comprises at least seven layers.

12. The vapor barrier system of claim 11, wherein at least one layer of the multi-layered moisture impervious vapor barrier sheet includes additives selected from the group consisting of soil gas prohibitors, UV protection additives, antimicrobial additives, and fire retardant additives.

13. The vapor barrier system of claim 8, further comprising a tail section extending from a bottom portion of the vapor barrier system, the tail section configured to transition from a vertical orientation along the foundation wall to a horizontal orientation along a floor surface.

14. The vapor barrier system of claim 13, including a rigid form board mounted to the vapor barrier sheet.

15. A vapor barrier and insulation assembly for a foundation wall, comprising:
a non-woven synthetic fiber layer configured to engage a foundation surface without mechanical fasteners;
a moisture impervious layer attached to the non-woven synthetic fiber layer;
an insulation layer adjacent to the moisture impervious layer; and
a perforated cover layer enclosing the insulation layer to the moisture impervious layer.

16. The vapor barrier and insulation assembly of claim 15, wherein the non-woven synthetic fiber layer comprises hydrophobic polypropylene fibers configured to draw moisture away from the foundation surface.

17. The vapor barrier and insulation assembly of claim 16, wherein the hydrophobic polypropylene fibers form air pockets between the fibers to increase capillary effect for drawing water away from the foundation surface.

18. The vapor barrier and insulation assembly of claim 15, wherein the moisture impervious layer comprises a multi-layered polyethylene film, and wherein at least one layer of the multi-layered polyethylene film includes ground nylon for puncture and abrasion resistance.

19. The vapor barrier and insulation assembly of claim 18, wherein the multi-layered polyethylene film includes additives selected from the group consisting of soil gas prohibitors, UV protection additives, antimicrobial additives, and fire retardant additives.

20. The vapor barrier and insulation assembly of claim 15, further comprising a tail section extending from a bottom portion of the assembly, the tail section configured to transition from a vertical orientation along the foundation wall to a horizontal orientation along a floor surface and engage with a floor covering to provide a continuous moisture barrier.

21. A vapor barrier and insulation system for a foundation wall, comprising:
a non-woven fibrous outer layer configured to engage a vertical foundation surface;
a vapor barrier layer adjacent to the non-woven fibrous outer layer;
at least one foam insulation layer adjacent to the vapor barrier layer;
a reflective layer adjacent to the at least one foam insulation layer;
an outer cover layer secured to the vapor barrier layer and enclosing the at least one foam insulation layer and the reflective layer; and
at least one spacer disposed between the reflective layer and the outer cover layer to maintain an air gap.

22. The vapor barrier and insulation system of claim 21, wherein the at least one foam insulation layer comprises:
a first foam insulation section adjacent to the vapor barrier layer;
a second foam insulation section;
a divider section separating the first foam insulation section and the second foam insulation section;
wherein a series of grooves and ridges are formed in the first foam insulation section and the second foam insulation section; and,
wherein the grooves and ridges are aligned to form continuous insulation cavities separated by the divider section that extend vertically through the foam insulation sections.

23. The vapor barrier and insulation system of claim 21, wherein the at least one foam insulation layer includes a series of grooves and ridges forming insulation cavities that extend vertically through the system.

24. The vapor barrier and insulation system of claim 23, wherein the insulation cavities facilitate compression of the insulation layer when rolling up the system for transportation prior to installation.

25. The vapor barrier and insulation system of claim 21, wherein the outer cover layer comprises a breathable material that allows water vapor to pass through while preventing liquid water penetration.

26. The vapor barrier and insulation system of claim 21, further comprising an insert slot formed in a top portion of the outer cover layer, the insert slot configured to allow insertion of additional components after initial installation.

27. The vapor barrier and insulation system of claim 26, further comprising a slot cover configured to seal the insert slot when not in use.

28. The vapor barrier and insulation system of claim 27, wherein the slot cover comprises a vapor barrier tape.

29. The vapor barrier and insulation system of claim 21, wherein the at least one spacer comprises a flexible material configured to compress or bend during installation while maintaining the air gap.

30. The vapor barrier and insulation system of claim 21, wherein the at least one foam insulation layer comprises a flexible closed cell foam material that allows the system to be rolled up for transportation and storage.

31. The vapor barrier and insulation system of claim 21, wherein the reflective layer comprises a metallic foil configured to reflect radiant heat.

32. The vapor barrier and insulation system of claim 21, further comprising a tail section extending from a bottom portion of the system, the tail section configured to transition from a vertical orientation along the foundation wall to a horizontal orientation along a floor surface.
